(19) United States
(12) Patent Application Publication
(10) Pub. No.: US 2011/0035429 A1
(43) Pub. Date: Feb. 10, 2011

(54) COMPOSITE EVENT DETECTION/DISTRIBUTION SYSTEM, COMPOSITE EVENT DETECTION/DISTRIBUTION METHOD, AND COMPOSITE EVENT DETECTION/DISTRIBUTION PROGRAM

(75) Inventor: Hiroshi Dempo, Tokyo (JP)

Correspondence Address: Mr. Jackson Chen, 6535 N. STATE HWY 161, IRVING, TX, 75039, US

(73) Assignee: NEC CORPORATION, Tokyo (JP)

(21) Appl. No.: 12/918,868

(22) PCT Filed: Feb. 17, 2009
(86) PCT No.: PCT/JP2009/052623

§ 371 Date: Aug. 23, 2010

(30) Foreign Application Priority Data
Feb. 29, 2008 (JP) 2008-050220

(51) Int. Cl. G06F 13/00; G06F 15/16

(52) U.S. Cl. 709/201

(57) ABSTRACT

A composite event detection/distribution system is provided with an associated event detection node that transfers, when detecting an associated event associated with the detection of a composite event generated by combining a plurality of events, the associated event that is detected to a route node and the route node that generates, when receiving the associated event from the associated event detection node, a composite event on the basis of the associated event that is received and that transfers the generated composite event to another node according to a set content.

### TECHNICAL FIELD

The present invention relates to a technique of distributing a state variation of a certain one object as one event and of generating/detecting a composite event by combining individual events. Furthermore, the present invention relates to a broker node provided for a composite event detection/distribution system.

### BACKGROUND ART

Sensing of an object in a real space is performed by using a hardware-like sensor device, RFID or the like. Furthermore, operating situations of various kinds of software in a computer system are monitored by using software. High-volume data thus monitored is subjected to mining processing and a state denoted by the set of data can thereby be grasped. The “event” stands for a change in the state of an object.

Here, it is further desirable to make detectable a composite event generated by combining individual events to thereby realize a higher degree of event distribution. As an example of a composite event, an event indicating congestion is defined as “when a queue of cars 1 km long moving at 40 km per hour or less continues for 15 minutes or more” according to the Highway Public Corporation. It is assumed from this example that three single events are simultaneously established; “event 1=car speed is 40 km per hour or less,” “event 2=a queue of cars 1 km long exists” and “event 3=states of event 1 and event 2 are continuing to occur concurrently for 15 minutes or more.”

Therefore, regarding the occurrence of congestion, a congestion event occurs when a logical expression “composite event=(event 1) AND (event 2) AND (event 3)” is satisfied.

For example, JP2004-164107A (hereinafter referred to as “Patent Document 1”) describes a case of related art that realizes composite event processing. The case described in Patent Document 1 shows server-intensive event processing and illustrates a model in which an analysis terminal set up on a network edge detects events and concentrates the detected events in a management terminal where the events are processed in a concentrated manner. Furthermore, for example, JP2006-309701A (hereinafter referred to as “Patent Document 2”) describes a load balancing/distribution system configured such that a processing server detects all events from an RFID tag according to a rule setting and then notifies the detection to an application as another example of the server-intensive type.

Furthermore, another case of related arts for realizing composite event processing is described in Peter R. Pietzuch, “A scalable event-based middleware” June 2004, pp 135-153 (hereinafter referred to as “Non-Patent Document 1”). According to the scheme described in Non-Patent Document 1, the system provides a composite event detection process with a migration function and thereby detects different events while performing process migration. For this reason, according to the scheme described in Non-Patent Document 1, although the system is provided with a function of supporting a composite event, the system has a problem of increasing the network load.

### DISCLOSURE OF THE INVENTION

A server bottleneck is the biggest problem of the server-intensive model described in Patent Document 1 and Patent Document 2 and the server load increases as events are diversified. Examples of solutions to this problem may include the addition of a server and distribution of an event type to be processed to each server. However, under such a server-intensive scheme, there is no means for associating events processed by different servers and processing those events as a composite event, and it is difficult to realize distribution of the composite event. Patent Document 2 describes that a plurality of events are detected and notified, but discloses nothing about generating a composite event based on the plurality of detected events and distributing the composite event, and it is therefore impossible to realize distribution of the composite event.

Furthermore, if a composite event is generated and distributed using the process migration described in Non-Patent Document 1, all data of the process itself is moved, and thus its demerit is that a large amount of data is transferred. That is, if the number of individual single events included in a composite event increases, the number of times migration occurs increases accordingly, and as a result, the load on the network increases. Moreover, increasing the number of types of composite event is also problematic because this increases the number of times that migration occurs, which constitutes a factor of increasing the network load.

Thus, the present invention has been implemented to solve the above described problems and it is an object of the present invention to provide a technique capable of reducing the concentration of load on a node that detects and distributes a composite event as the number of types of composite event increases.

A composite event detection/distribution system of the present invention is provided with an associated event detection node that transfers, when detecting an associated event associated with the detection of a composite event generated by combining a plurality of events, the associated event that is detected to a route node and the route node that generates, when receiving the associated event from the associated event detection node, a composite event on the basis of the associated event that is received and that transfers the generated composite event to another node according to a set content.

A broker node of the present invention is provided with receiving means for receiving a composite event generated by combining a plurality of events, composite event generating means for generating a composite event on the basis of the associated event received by the receiving means and composite event distributing means for transferring the composite event generated by the associated event generating means to another node according to the set content.

A composite event detection/distribution method of the present invention is a method for, when detecting an associated event associated with the detection of a composite event generated by combining a plurality of events, transferring the associated event that is detected to a route node, generating, when receiving the associated event, a composite event on the basis of the associated event received and transferring the generated composite event to another node according to the set content.

A composite event detection/distribution program of the present invention is a program for causing a computer to execute a receiving procedure for receiving a composite event generated by combining a plurality of events, a composite event generating procedure for generating a composite event on the basis of the associated event received in the receiving procedure and a composite event distributing procedure for transferring the composite event generated in the associated event generating procedure to another node according to the set content.

The present invention can reduce concentration of load on a node that detects and distributes a composite event as the number of types of composite event increases.

### BRIEF DESCRIPTION OF THE DRAWINGS

FIG. 1 is a block diagram illustrating a configuration example of an entire composite event detection/distribution system according to the present invention;

FIG. 2 is a data structure diagram illustrating an event definition management mode;

FIG. 3 is a diagram illustrating a relationship between an event definition plane and event distribution;

FIG. 4 is a block diagram illustrating a configuration example of a publisher node;

FIG. 5 is a block diagram illustrating a configuration example of a broker node;

FIG. 6 is a block diagram illustrating a configuration example of a subscriber node;

FIG. 7 is a flowchart illustrating a flow of multicast tree construction and event distribution in a composite event detection/distribution system;

FIG. 8 is a diagram illustrating a flow of multicast tree construction from route node R1 to subscriber nodes S2, S4 and S5;

FIG. 9 is a diagram illustrating a flow of multicast tree construction from route node R2 to subscriber node S1;

FIG. 10 is a diagram illustrating specific event routing when distributing events from publisher node P1 to subscriber nodes S2, S4 and S5;

FIG. 11 is a diagram illustrating specific event routing when distributing an event from publisher node P2 to subscriber node SI;

FIG. 12 is a flowchart illustrating a flow of detecting and distributing a composite event in the composite event detection/distribution system;

FIG. 13 is a diagram illustrating a route node setting method for a composite event;

FIG. 14 is a diagram illustrating an example of content of a composite event registration;

FIG. 15 is a diagram illustrating an example of registered content of associated event A1;

FIG. 16 is a diagram illustrating an example of registered content of associated event B1;

FIG. 17 is a diagram illustrating an example of composite event distribution;

FIG. 18 is a diagram illustrating the operations of collecting associated events A1 and B1 and of detecting composite event C1;

FIG. 19 is a diagram illustrating the operation of each broker node;

FIG. 20 is a diagram illustrating an example of a routing table of a broker node for composite event detection and distribution; and

FIG. 21 is a configuration diagram illustrating a minimum configuration example of the composite event detection/distribution system.

### BEST MODE FOR CARRYING OUT THE INVENTION

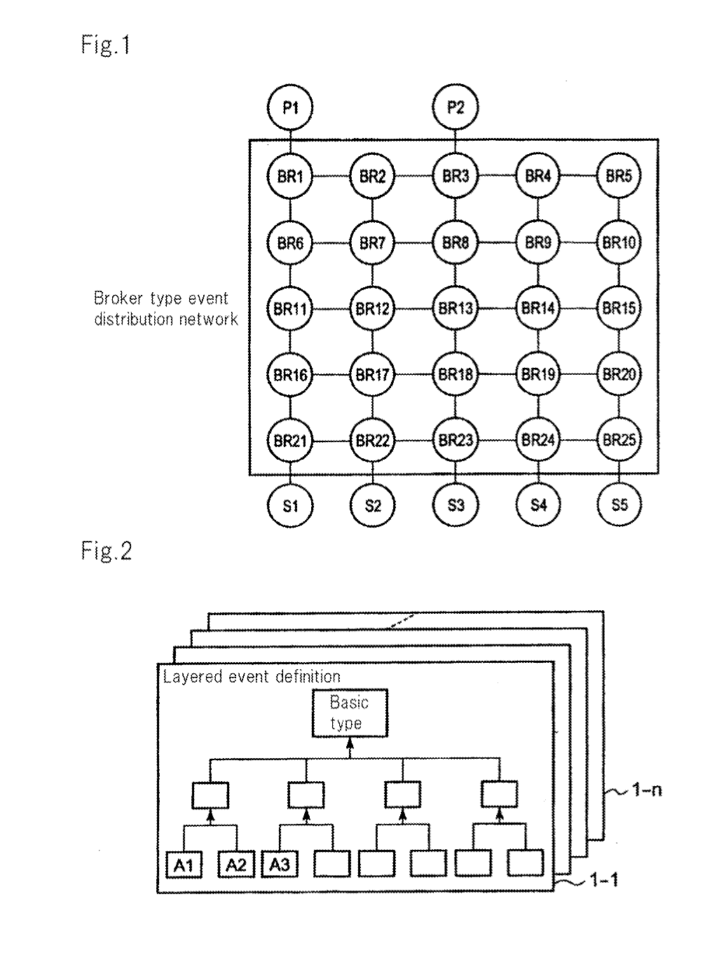

Hereinafter, exemplary embodiments will be described with reference to the accompanying drawings. First, an overview and configuration of a composite event detection/distribution system of the present invention will be described. FIG. 1 is a block diagram illustrating a configuration example of the entire composite event detection/distribution system of the present invention. As shown in FIG. 1, the composite event detection/distribution system includes three types of nodes; publisher nodes P1 and P2, broker nodes BR1 to BR25 that route events and subscriber nodes S1 to S5 that receive events. Furthermore, when set as route nodes, broker nodes BR1 to BR25 also function as route nodes that perform event distribution processing in the present embodiment.

The composite event detection/distribution system of the present invention is intended to use a publish/subscribe type communication scheme. According to this publish/subscribe scheme, publisher nodes P1 and P2 classify various kinds of information by topic and publish the information, and subscriber nodes S1 to S5 perform reception registration for topics of interest. As a result, information subjected to reception registration is routed and distributed from publisher nodes P1 and P2 to subscriber nodes S1 to S5. In the present invention, the composite event detection/distribution system classifies various events transmitted by publisher nodes P1 and P2 by topic.

First of all, events will be described. Each event basically has an ID to be distinguished from each other. Events distributed from publisher nodes P1 and P2 to subscriber nodes S1 to S5 are provided with IDs to identify the events. Intermediate broker nodes BR1 to BR25 that relay those events perform routing processing using the event IDs as keys.

Publisher nodes P1 and P2 generate unique event IDs for various events generated using a hash function or the like. The method described above whereby publisher nodes P1 and P2 generate event IDs is described, for example, in Non-Patent Document 1. Furthermore, various events are classified into a basic event type and an inheritance event type according to their data types. FIG. 2 is a diagram illustrating a data structure of an event. An event generated by a publisher node is provided with a data structure such as layered event definition plane 1-1 shown in FIG. 2.

The basic event type (hereinafter also simply referred to as “basic type”) includes only minimum necessary information. For example, the information included in the basic event type is limited to only a basic event ID and event occurrence time or the like. The inheritance event type is a type obtained by expanding the basic event type, includes an ID to identify a parent event type with which the basic event type has an inheritance relationship and an information element pertaining to the parent event. The kind of information element that should be included differs depending on the definition of each event. Furthermore, each information element can also include a value (e.g., date and time at which the event is created) as attribute information.

The information format on the event as shown in FIG. 2 is expressed, for example, in an XML format. Such a data structuring technique can support a variety of event definitions. Furthermore, as shown in FIG. 2, providing a plurality of event definition planes 1-1 to 1-n according to events can improve diversity. Event definition planes 1-1 to 1-n are defined in a one-to-one correspondence with events.

For example, according to the related art described in Non-Patent Document 1, publisher nodes P1 and P2 are provided with a function of creating the event definition planes as shown in FIG. 2. That is, this is a model in which the information transmitter side controls information to be transmitted. On the other hand, according to the composite event detection/distribution system of the present invention, subscriber nodes S1 to S5 are also provided with the function of creating the composite event definition planes to generate a composite event. By so doing, various events published by publisher nodes P1 and P2 can be freely combined into a composite event according to preferences of subscriber nodes S1 to S5.

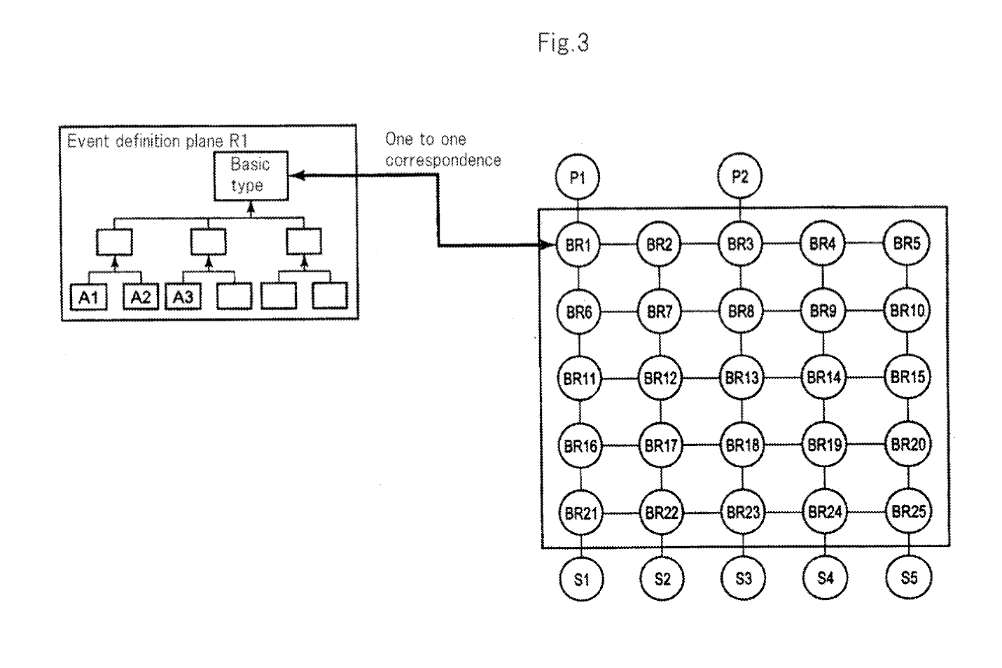

As for a relationship between an event definition plane and event distribution, one event distribution route node is provided for each event definition plane as shown in FIG. 3 in the present embodiment. The configuration of the composite event detection/distribution system shown in FIG. 3 includes publisher nodes P1 and P2, broker nodes BR1 to BR25 and subscriber nodes S1 to S5. Furthermore, broker nodes BR1 to BR25 also function as route nodes. The present embodiment will describe a case where broker node BR1 also functions as route node R1 and broker node BR3 also functions as route node R2, as will be described later.

Suppose broker nodes BR1 to BR25 are connected as shown in FIG. 3 constituting a broker type event distribution network. The connection mode shown in FIG. 3 is simply an example and broker nodes BR1 to BR25 may also be connected in other connection modes. Publisher nodes P1 and P2 distribute events to route nodes R1 and R2 provided (set) for each event. On the other hand, events are distributed from route nodes R1 and R2 to subscriber nodes S1 to S5 according to a multicast tree.

To be more specific, publisher nodes P1 and P2 are realized by an information processing apparatus such as a personal computer that operates according to a program. Although two publisher nodes R1 and R2 are shown in FIG. 1, the number of publisher nodes is not limited to two and the composite event detection/distribution system may include three or more publisher nodes.

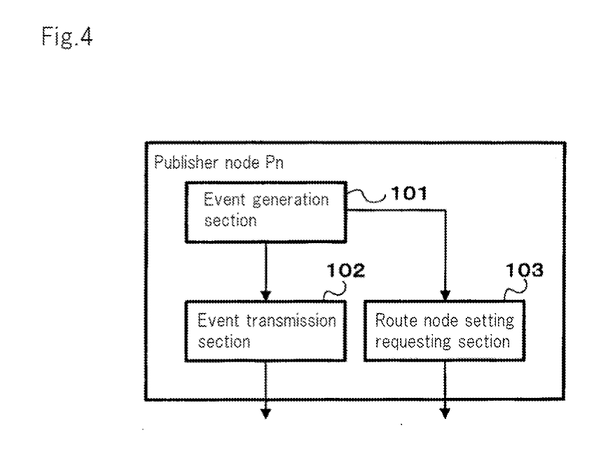

FIG. 4 is a block diagram illustrating an example of the configuration of publisher nodes P1 and P2. As shown in FIG. 4, publisher nodes P1 and P2 include event generation section 101, event transmission section 102 and route node setting requesting section 103.

To be more specific, event generation section 101 is realized by a CPU of an information processing apparatus that operates according to a program. Event generation section 101 is provided with a function of generating an event based on an input of a detection signal from various sensors (e.g., speed sensor) or tag (e.g., RFID tag). When, for example, a publisher node is a server run by a road management organization, event generation section 101 generates an event such as “the car speed is 40 km per hour or less” based on a detection signal from a speed sensor. Furthermore, event generation section 101 is provided with a function of generating an event ID to identify the event generated.

To be more specific, event transmission section 102 is realized by a CPU and a network interface section of an information processing apparatus that operates according to a program. Event transmission section 102 is provided with a function of transmitting an event generated by event generation section 101 to route nodes R1 and R2.

To be more specific, route node setting requesting section 103 is realized by a CPU and a network interface section of an information processing apparatus that operates according to a program. Route node setting requesting section 103 is provided with a function of selecting, when event generation section 101 generates a new event, a node to be set as a route node out of broker nodes BR1 to BR25. In the present embodiment, route node setting requesting section 103 selects a broker node having an ID (node ID) numerically close to an event ID corresponding to the new event. Furthermore, route node setting requesting section 103 is provided with a function of transmitting a setting request as a route node to the selected broker node so that the selected broker node is set as a route node.

Furthermore, broker nodes BR1 to BR25 in the composite event detection/distribution system detect associated events associated with the detection of a composite event, accumulate the detected associated events and detect a composite event. Furthermore, route nodes R1 and R2 (to be exact, broker nodes set as route nodes) cause other broker nodes to detect associated events.

To be more specific, broker nodes BR1 to BR25 are realized by a network apparatus such as an IP router or an information processing apparatus such as a personal computer mounted with a router function that operates according to a program. Broker nodes BR1 to BR25 are provided with a function of relaying an event between publisher nodes P1 and P2, and subscriber nodes S1 to S5. FIG. 1 shows 25 broker nodes BR1 to BR25 but the number of broker nodes is not limited to 25.

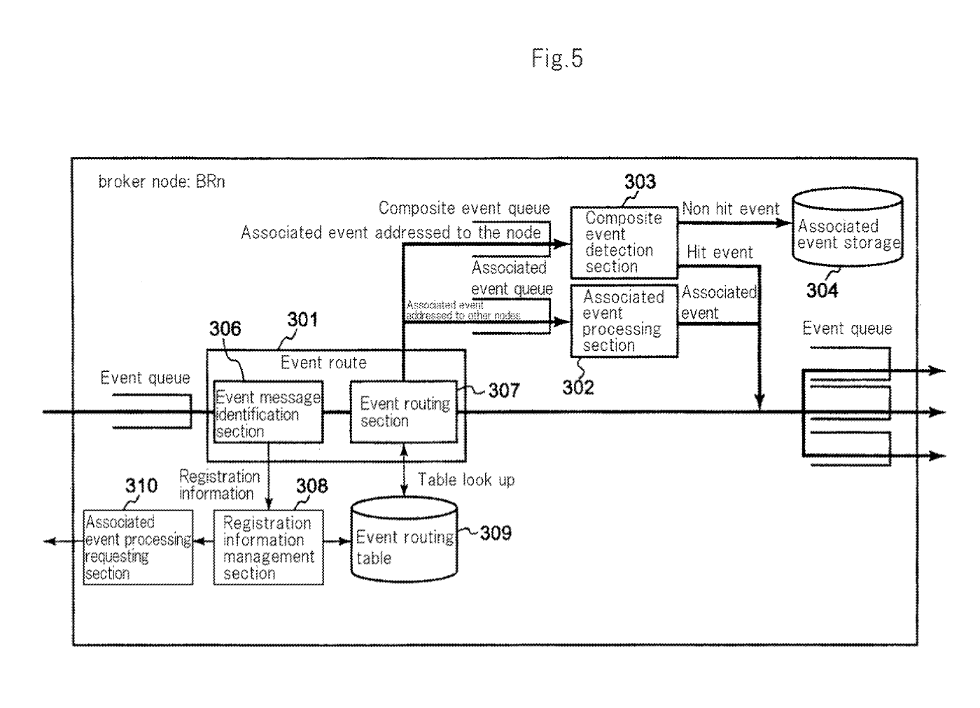

FIG. 5 is a block diagram illustrating a configuration example of broker nodes BR1 to BR25. As shown in FIG. 5, broker nodes BR1 to BR25 include event router 301, associated event processing section 302, composite event detection section 303, associated event storage 304, registration information management section 308, event routing table 309 and associated event processing requesting section 310. Furthermore, event router 301 includes event message identification section 306 and event routing section 307.

Event message identification section 306 is provided with a function of identifying whether information received from publisher nodes P1 and P2, subscriber node S1 to S5 or other broker nodes is an event or message. Furthermore, event message identification section 306 is provided with a function of distributing and outputting an event or message to event routing section 307 or registration information management section 308 based on the identification result.

Event routing section 307 is provided with a function of transmitting an event or message to publisher nodes P1 and P2, subscriber node S1 to S5 or other broker nodes, which are the transfer or transmission destinations, via an event queue according to the set content of event routing table 309. Furthermore, when the associated event processing function of a broker node is activated, event routing section 307 is provided with a function of outputting, upon receiving an associated event (single event associated with detection of a composite event), the associated event to associated event processing section 302. Furthermore, when a broker node is set as a route node for composite event detection, event routing section 307 is provided with a function of outputting, upon receiving an associated event, the associated event to composite event detection section 303.

Registration information management section 308 is provided with a function of making various settings based on a message from event message identification section 306. Upon receiving, for example, a route node setting request from publisher nodes P1 and P2 as a message, registration information management section 308 sets the broker node as a route node. When, for example, the broker node is set as a route node, upon receiving a reception registration from subscriber nodes S1 to S5 as a message, registration information management section 308 sets the subscriber node as the distribution destination of the event. Furthermore, upon receiving, for example, an associated event processing request as a message, registration information management section 308 causes associated event processing section 302 to activate the associated event processing function.

To be more specific, event routing table 309 is stored in a storage apparatus such as a memory or magnetic disk apparatus provided for the broker node. Event routing table 309 includes information indicating broker nodes of transfer destinations (e.g., node IDs) in association with their event IDs. Furthermore, event routing table 309 includes information indicating broker nodes of transfer destinations (e.g., node IDs) in association with destination publisher nodes P1 and P2 or subscriber nodes S1 to S5.

Associated event processing requesting section 310 is provided with a function of transmitting, when the broker node is set as a route node for composite event detection, an associated event processing request for requesting the detection of an associated event associated with the detection of the composite event to be detected to another broker node.

Associated event processing section 302 is provided with a function of applying predetermined processing to the detected associated event and transmitting the associated event to the other broker node set as the route node for composite event detection.

Composite event detection section 303 is provided with a function of detecting, when the broker node is set as a route node for composite event detection, a composite event based on the detected associated event. Furthermore, composite event detection section 303 is provided with a function of transmitting the detected composite event to a broker node of the transfer destination.

To be more specific, associated event storage 304 is realized by a storage apparatus such as a memory or magnetic disk apparatus provided for the broker node. Associated event storage 304 temporarily stores an associated event before being detected by composite event detection section 303 as a composite event.

As described above, subscriber nodes S1 to S5 transmit composite event registration information to freely combine various published events into a composite event. Subscriber nodes S1 to 55 are servers run by a service provider who distributes various kinds of information such as congestion information to each user. Subscriber nodes S1 to S5 distribute various kinds of information such as congestion information to each user's terminal such as cellular phone set or personal computer via a communication network such as a cellular phone network or the Internet based on, for example, a received event (including a composite event).

To be more specific, subscriber nodes S1 to S5 are realized by information processing apparatuses such as personal computers that operate according to a program. Although FIG. 1 shows five subscriber nodes S1 to S5, the number of subscriber nodes is not limited to five.

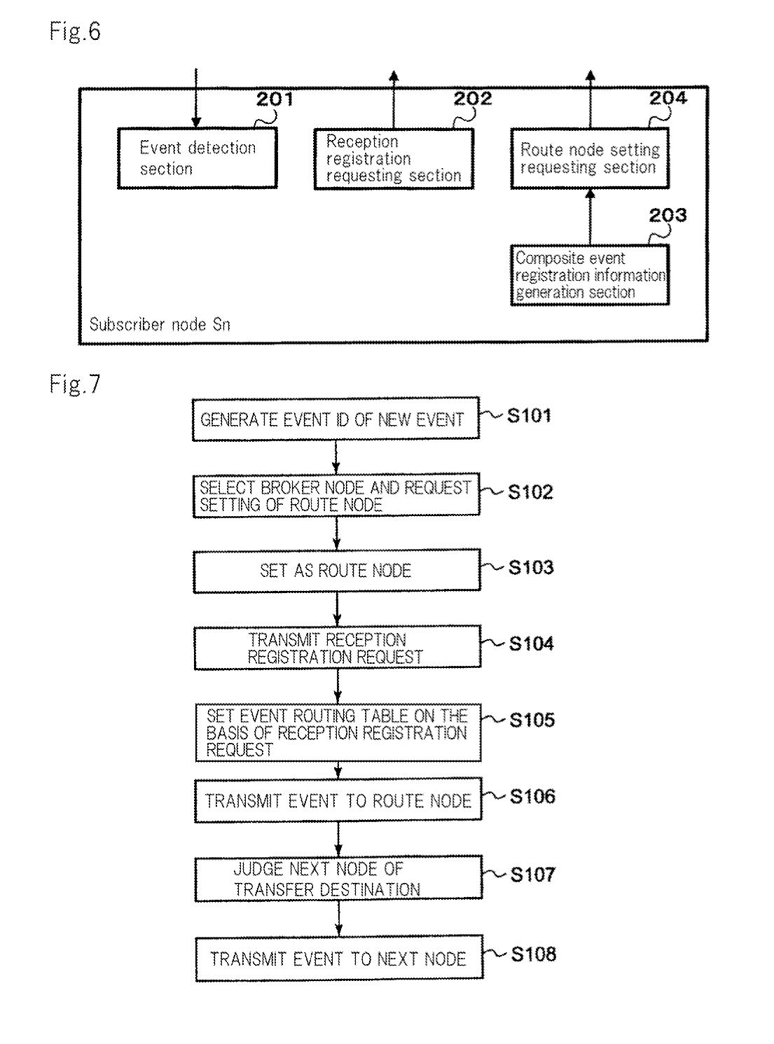

FIG. 6 is a block diagram illustrating a configuration example of subscriber nodes S1 to S5. As shown in FIG. 6, subscriber nodes S1 to S5 include event receiving section 201, reception registration requesting section 202, composite event registration information generation section 203 and route node setting requesting section 204.

To be more specific, event receiving section 201 is realized by a CPU and a network interface section of an information processing apparatus that operates according to a program. Event receiving section 201 is provided with a function of receiving events via a broker type event distribution network including broker nodes BR1 to BR25.

To be more specific, reception registration requesting section 202 is realized by a CPU and a network interface section of an information processing apparatus that operates according to a program. Reception registration requesting section 202 is provided with a function of generating a reception registration request for registering an event desired to be received and transmitting the reception registration request to a route node that distributes the event.

To be more specific, composite event registration information generation section 203 is realized by a CPU of an information processing apparatus that operates according to a program. Composite event registration information generation section 203 is provided with a function of generating composite event registration information to register a composite event desired to be received.

To be more specific, route node setting requesting section 204 is realized by a CPU and a network interface section of an information processing apparatus that operates according to a program. Route node setting requesting section 204 is provided with a function of transmitting the composite event registration information generated by composite event registration information generation section 203 to a route node that distributes a composite event.

When broker nodes BR1 to BR25 of the present embodiment are realized using information processing apparatuses, a storage apparatus (not shown) of each broker node BR1 to BR25 stores various programs to detect and distribute a composite event. For example, the storage apparatus of each broker node BR1 to BR25 stores a composite event detection/distribution program that causes a computer to execute associated event transfer processing of transferring, upon detecting an associated event when the broker node is set as an associated event detection node for detecting an associated event associated with the detection of a composite event, the detected associated event to a broker node set as a route node that performs processing of distributing the composite event, composite event generation processing of generating, upon receiving an associated event from a broker node set as an associated event detection node when the broker node is set as a route node, a composite event based on the received associated event, and composite event distribution processing of transferring the composite event generated to another node according to the set content.

Next, the operation will be described. Hereinafter, a multicast tree construction method and event distribution method for distributing an event will be described with a specific example. FIG. 7 is a flowchart illustrating a flow of multicast tree construction and event distribution in the composite event detection/distribution system. An event distribution system is constructed for each single event according to the flow shown in FIG. 7.

The present embodiment assumes that publisher nodes P1 and P2, broker nodes BR1 to BR25 and subscriber nodes S1 to S5 are operating as software processes. The present embodiment also assumes that route node R1 set on broker node BR1 and route node R2 set on broker node BR3 are operating as software processes.

Suppose route node R1 of the present embodiment is a route node that performs event distribution processing on events A1, A2 and B3, which will be described later. Furthermore, suppose route node R2 is a route node that performs event distribution processing on event B1, which will be described later.

Furthermore, the present embodiment will describe a case where broker nodes BR1 and BR3 are set as route nodes as an example, but all broker nodes BR1 to BR25 of the composite event detection/distribution system are each mounted with a function of operating as a route node. Therefore, broker nodes other than broker nodes BR1 and BR3 can also be selected and set as route nodes in the composite event detection/distribution system.

Suppose an overlay network exists in a lower layer of the composite event detection/distribution system in the present embodiment. The overlay network is a distributed application network using a Distributed Hash Table (DHT). In the overlay network, each node is provided with a unique node ID. Routing is performed according to this node ID.

First, when a new event is generated, publisher node P1 creates a basic event type definition for the newly generated event. When a new basic event type is defined, publisher node P1 generates a unique event ID on the system using a hash function or the like (step S101).

When the basic event type generated is publicized to the composite event detection and distribution system, one broker node BR1 is selected and a route node R1 function is activated in this broker node BR1. To be more specific, publisher node P1 selects a route node corresponding to the newly generated event from among a plurality of broker nodes BR1 to BR25. Publisher node P1 then transmits a route node setting request to selected broker node BR1 (step S102). Broker node BR1 then activates the function as the route node and is set as route node R1 (step S103).

Since this broker node BR1 of the present embodiment has a node ID numerically close to, for example, the new event ID, suppose broker node BR1 is selected by publisher node P1. The method of selecting a broker node as a route node is not limited to the method shown in the present embodiment. For example, publisher node P1 may select a broker node having the least current processing load as a route node.

The relationship between publisher node P1 and route node R1 is constructed by performing the above described processing. In the present embodiment, event IDs are distributed and assigned by randomly selecting route nodes using a method of selecting a broker node with a node ID numerically close to a new event ID or the like. By so doing, it is possible to prevent events from concentrating on a route node, causing the load on the specific route node to increase.

When a new event is generated according to processing similar to that in step S101 to S103, publisher node P2 selects broker node BR3 as a route node and sets route node R2 on broker node BR3.

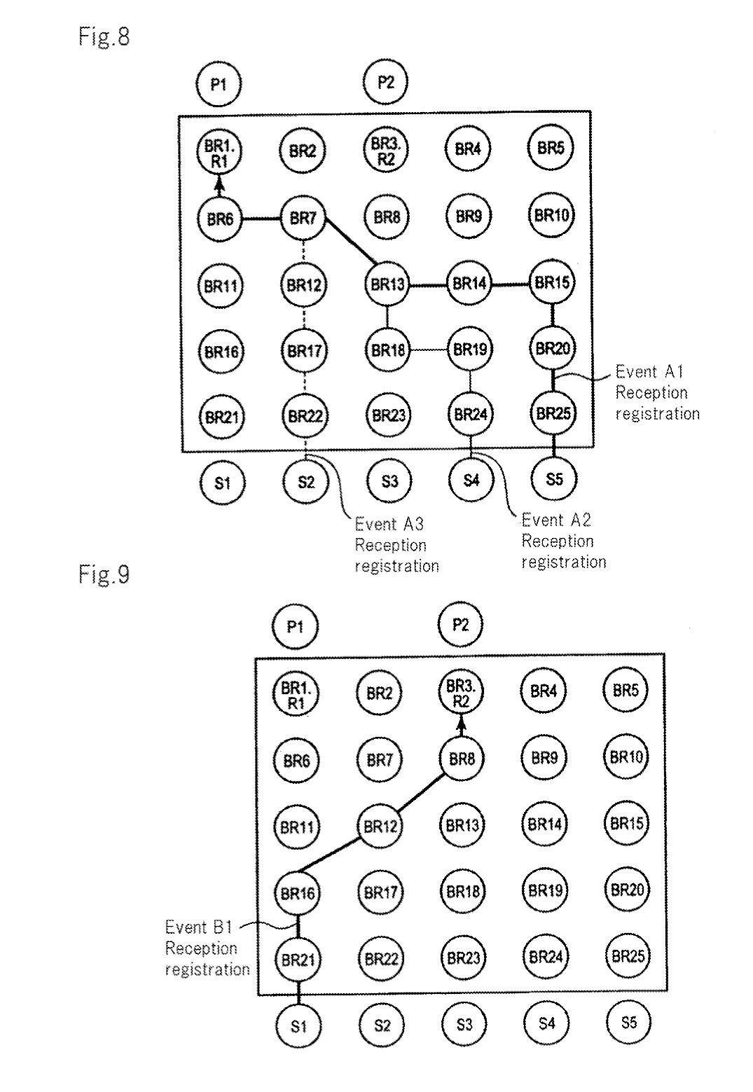

Next, a flow of multicast tree construction from route nodes R1 and R2 to subscriber nodes S1 to S5 will be described. FIG. 8 is a diagram illustrating a flow of multicast tree construction from route node R1 to subscriber nodes S2, S4 and S5. On the other hand, FIG. 9 is a diagram illustrating a flow of multicast tree construction from route node R2 to subscriber node S1.

Suppose information (e.g., event ID) on events that can be transmitted by publisher nodes P1 and P2 are publicized via Web sites or the like opened on publisher nodes P1 and P2. Suppose subscriber nodes S1 to S5 can acquire information such as event ID of an event desired to be received beforehand.

When, for example, a provider running subscriber node S5 wants to receive event A1 transmitted by publisher node P1, the provider operates subscriber node S5 and performs reception registration operation on event A1. Subscriber node S5 then transmits a reception registration request for receiving event A1 to route node R1 (step S104).

The reception registration request transmitted by subscriber node S5 includes an event ID to identify the basic event type of event A1. Therefore, as shown in FIG. 8, broker nodes BR25, BR20, BR15, BR14, BR13, BR7, BR6 and BR1, intermediate between subscriber node S5 and publisher node P1 check the event ID of this basic event type and perform routing to route node R1.

Each broker node sets information indicating the correspondence between the destination and a broker node to which the request is to be transferred in event routing table 309 beforehand. For example, upon receiving a reception registration request whose destination is route node R1 from subscriber node S5, broker node BR25 identifies broker node BR20 which is the transfer destination based on the set content of event routing table 309 and transfers the received reception registration request to broker node BR20. Upon receiving event A1 based on the received reception registration request, broker node BR20 sets setting information indicating that received event A1 is transferred to broker node BR25 in event routing table 309 (step S105).

As shown in FIG. 8, broker nodes BR25, BR20, BR15, BR14, BR13, BR7, BR6 and BR1 sequentially perform the above described processing. By so doing, when a broker node has no entry for event A1 whose reception registration is requested, a routing entry thereof is newly added to event routing table 309.

When event A1 is transmitted from publisher node P1 by performing the above described processing, subscriber node S5 is enabled to receive event A1 via broker nodes BR1, BR6, BR7, BR13, BR14, BR15, BR20 and BR25 through event distribution processing by route node R1.

The present embodiment will describe a case where event A1 is distributed to subscriber node S5 from publisher node P1 via the route of broker nodes BR1, BR6, BR7, BR13, BR14, BR15, BR20 and BR25 as an example, but the distribution route of event A1 is not limited to the route shown in the present embodiment. For example, event A1 may be distributed to subscriber node S5 through a different route according to the set content of event routing table 309 of broker nodes BR1 to BR25. The same applies to the distribution routes set for other events A2, A3 and B1.

When subscriber node S4 desires to receive event A2 according to processing similar to that in step S104, subscriber node S4 transmits a reception registration request for receiving event A2 to route node R1. As shown in FIG. 8, broker nodes BR24, BR19, BR18 and BR13, intermediate between subscriber node S4 and publisher node P1 set event routing table 309 according to processing similar to that in step S105.

However, when the reception registration request for event A2 from subscriber node S4 reaches broker node BR13, event routing table 309 has already been set for broker nodes BR7, BR6 and BR1 ahead of BR13 by the reception registration request from subscriber node S5. Therefore, broker nodes BR7, BR6 and BR1 need not make a new setting and the reception registration request from subscriber node S4 is terminated at BR13.

When event A2 is transmitted from publisher node P1 by performing the above described processing, subscriber node S4 can receive event A2 via broker nodes BR 1, BR6, BR7, BR13, BR18, BR19 and BR24 through event distribution processing by route node R1.

Furthermore, when subscriber node S2 desires to receive event A3 according to processing similar to that in step S104, subscriber node S2 transmits a reception registration request for receiving event A3 to route node R1. Broker nodes BR22, BR17, BR12 and BR7, intermediate between subscriber node S2 and publisher node P1 set event routing table 309 according to processing similar to that in step S105 as shown in FIG. 8.

However, when the reception registration request for event A3 from subscriber node S2 reaches broker node BR7, event routing table 309 has already been set for destination broker nodes BR6 and BR1 ahead of BR7 by the reception registration request from subscriber node S5. Therefore, broker nodes BR6 and BR1 need not make a new setting and the reception registration request from subscriber node S2 is terminated at BR7.

When event A3 is transmitted from publisher node P1 by performing the above described processing, subscriber node S2 is enabled to receive event A3 via broker nodes BR1, BR6, BR7, BR12, BR17 and BR22 through the event distribution processing by route node R1.

Furthermore, when subscriber node S1 desires to receive event B1 according to processing similar to that in step S104, subscriber node S1 transmits a reception registration request for receiving event B1 to route node R2. As shown in FIG. 9, broker nodes BR21, BR16, BR12, BR8 and BR3, intermediate between subscriber node S1 and publisher node P2 set event routing table 309 according to processing similar to that in step S105.

When event B1 is transmitted from publisher node P2 by performing the above described processing, subscriber node S1 is enabled to receive event A3 via broker nodes BR3, BR8, BR12, BR10 and BR21 through event distribution processing by route node R2. A reception registration request on event B1 is then routed from subscriber node S1 to route node R2 via broker nodes BR21, BR16, BR12, BR8 and BR3 and a multicast tree is constructed as well.

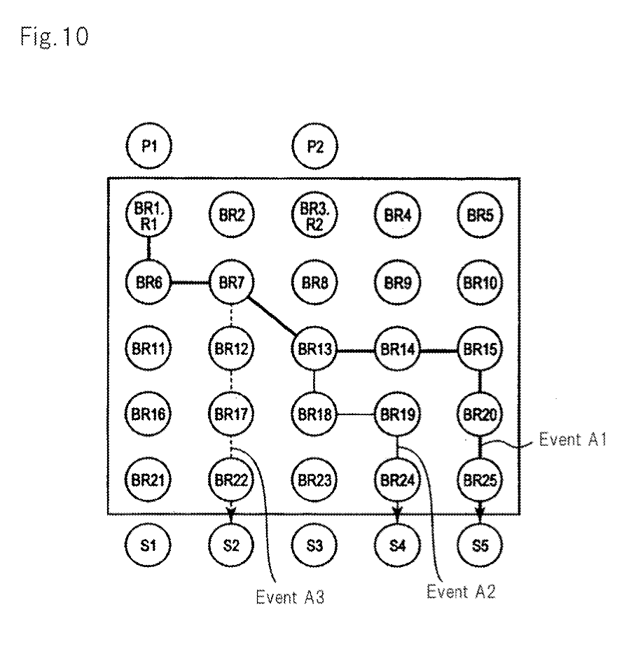

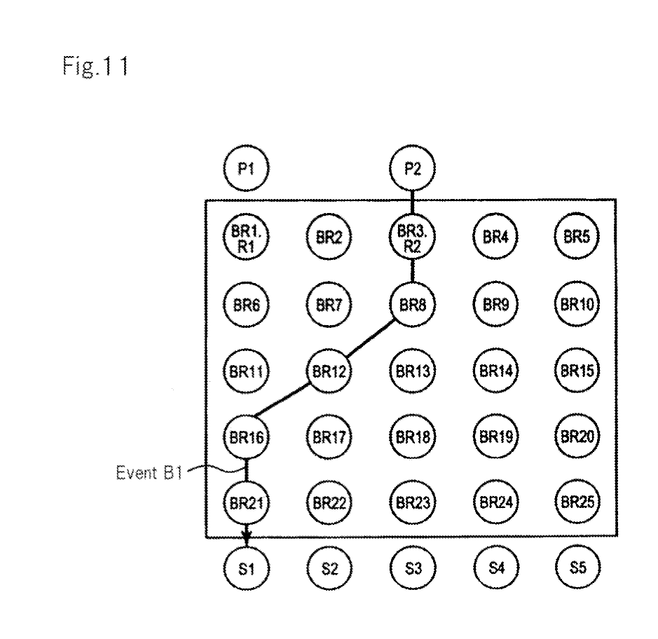

Next, more specific event routing when performing event distribution will be described. FIG. 10 is a diagram illustrating specific event routing when performing event distribution from publisher node P1 to subscriber nodes S2, S4 and S5. Furthermore, FIG. 11 is a diagram illustrating specific event routing when performing event distribution from publisher node P2 to subscriber node S1.

As shown in FIG. 10, publisher node P1 distributes event A1 to subscriber node 55, distributes event A2 to subscriber node S4 and distributes event A3 to subscriber node S2. In this case, when event A2 is distributed through the aforementioned routing setting processing, event A2 is branched at broker node BR13 and distributed. Furthermore, when event A is distributed, event A3 is branched at broker node BR7 and distributed.

First, publisher node P1 transmits event A1 to be transmitted to route node R1 which is the route node set on broker node BR1 (step S106). Events transmitted by this publisher node P1 include unique event type IDs assigned to the respective events.

Upon receiving event A1, broker node BR1 routes event A1 according to the set content of event routing table 309 using the event type ID included in received event A1 as a key. In this routing processing, broker node BR1 judges that received event A1 is directed to route node R1 and virtually distributes event A1 to route node R1 set on broker node BR1.

Next, route node R1 detects (extracts) event ID included in event A1. Furthermore, route node R1 judges that the next node to which event A1 is transferred is broker node BR6 on the basis of the detected event ID and event routing table 309 (step S107). Route node R1 then transfers event A1 to broker node BR6 (step S108).

After that, according to processing similar to that in steps S107 and S108, event A1 reaches broker node BR7 via broker node BR6. As shown in FIG. 10, the next two nodes in routing processing at broker node BR7 are broker node BR12 and broker node BR13. Thus, broker node BR7 creates a copy of event A1 and transmits the copy to the next nodes (broker nodes BR12 and BR13) respectively.

Furthermore, processing similar to the above described processing is also performed at broker node BR13, and broker node BR13 creates a copy of event A1 and transmits the copy to the next nodes (broker nodes BR14 and BR18) respectively.

By performing the processing shown in steps S107 and S108 at each broker node, each event is distributed from publisher node P1 as shown in FIG. 10. That is, regarding nodes from broker node BR13 onward, publisher node P1 distributes event A1 to subscriber node S5 via the route of broker nodes BR14, BR15, BR20 and BR25. On the other hand, regarding nodes from broker node BR13 onward, publisher node P1 distributes event A2 to subscriber node S4 via the route of broker nodes BR 18, BR19 and BR24. Furthermore, regarding nodes from broker node BR7 onward, publisher node P1 distributes event A3 to subscriber node S2 via the route of broker nodes BR12, BR17 and BR22.

The processing of distributing event B1 from publisher node P2 is also performed in a manner similar to that in steps S107 and S108. That is, as shown in FIG. 11, publisher node P2 distributes event B1 to subscriber node S1 via the route of broker node BR3 (route node R2), broker nodes BR8, BR12, BR16 and BR21.

The flow. of the above described multicast tree construction and event distribution is described, for example, in Non-Patent Document 1.

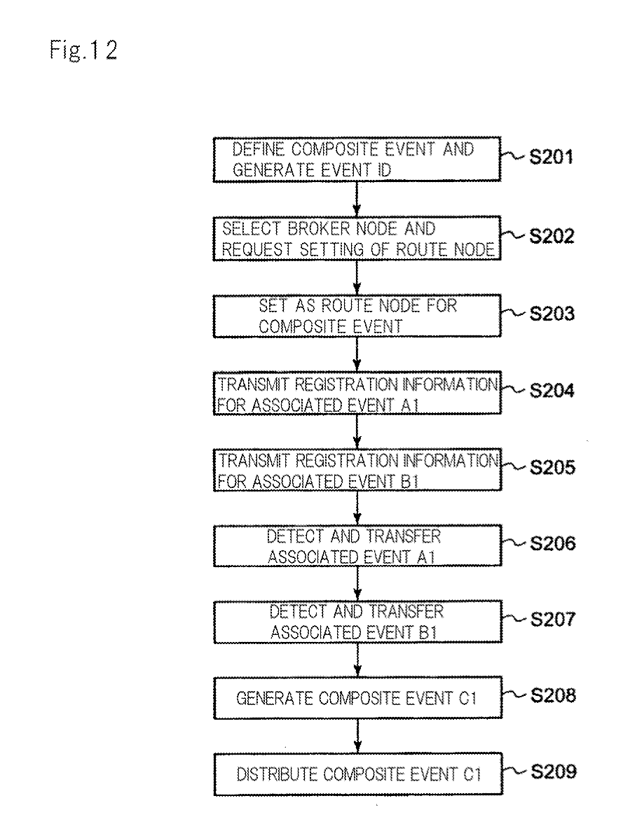

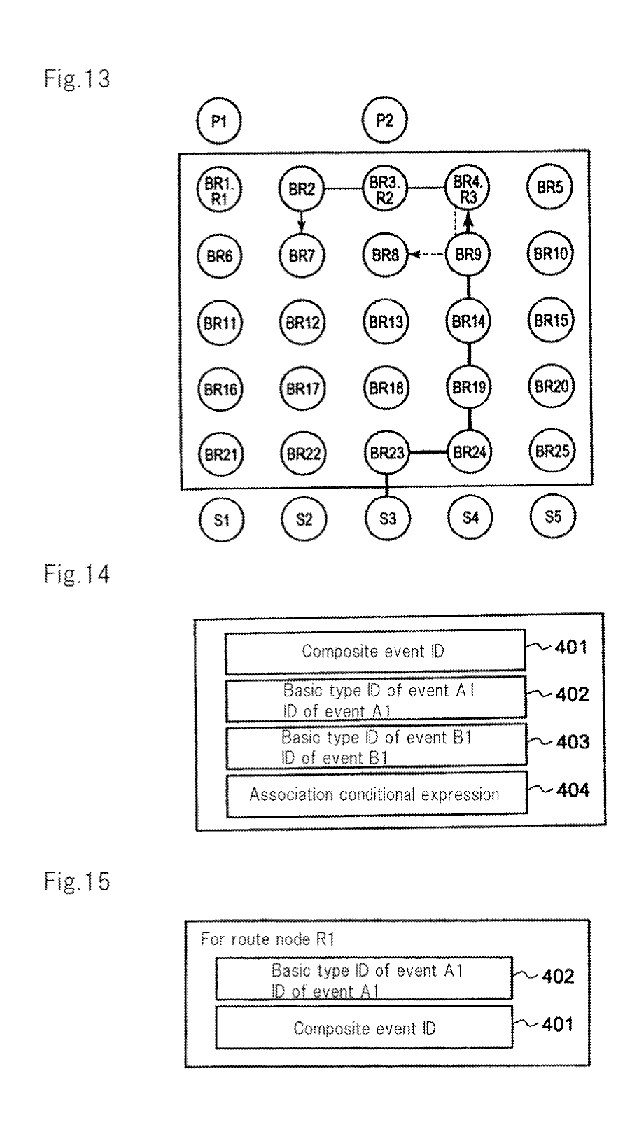

Next, the operation of detecting a composite event and distributing the detected composite event will be described as an expanded function of the constructed event distribution system. FIG. 12 is a flowchart illustrating the flow of detecting and distributing a composite event in the composite event detection/distribution system. FIG. 13 a diagram illustrating the route node setting method for a composite event.

In the example shown in the present embodiment, the “composite event” corresponds to an event generated by combining event A1 (that is, an event from publisher node P1 to subscriber node S5) and event B1 (that is, an event from publisher node P2 to subscriber node S1).

First, when, for example, a provider running subscriber node S3 desires to receive composite event C1 generated by combining event A1 and event B1, the provider operates subscriber node S3 to perform a definition operation of composite event C1. Subscriber node S3 then creates a definition of a basic event type on composite event C1 combining event A1 and event B1. Furthermore, subscriber node S3 generates an event ID to identify composite event C1 using a hash function or the like (step S201).

Subscriber node S3 then publicizes the basic event type through composite event registration, and route node R3 for a composite event is thereby confirmed. To be more specific, subscriber node S3 selects a route node corresponding to the newly defined composite event from among a plurality of broker nodes BR1 to BR25. Subscriber node S3 then transmits a route node setting request to selected broker node BR4 (step S202). Broker node BR4 then activates a function as a route node and makes a setting as route node R3 for a composite event (step S203).

In the present embodiment, as shown in FIG. 13, the route node setting request transmitted from subscriber node S3 is transmitted to broker node BR4 via broker nodes BR23, BR24, BR19, BR14 and BR9. The procedure whereby the route node setting request transmitted from subscriber node S3 is guided to broker node BR4 via broker nodes BR23, BR24, BR19, BR14 and BR9 is similar to the procedure whereby a reception registration request from a subscriber node is transmitted. That is, each of intermediate broker nodes BR23, BR24, BR19, BR14 and BR9 identifies a broker node of the transfer destination on the basis of the set content of event routing table 309 and transfers the route node setting request.

Furthermore, subscriber node S3 in the present embodiment selects broker node BR4 having a node ID numerically close to the event ID of composite event C1 using DHT as route node R3 for this composite event. The method of selecting a broker node to be selected as a route node for a composite event is not limited to the method shown in the present embodiment. For example, subscriber S3 may select a broker node with the least current processing load as a route node for a composite event.

Furthermore, although the present embodiment describes a case where broker node BR4 is set as a route node for a composite event as an example, all broker nodes BR1 to BR25 of the composite event detection/distribution system are mounted with a function of operating as a route node for a composite event. Therefore, any broker node other than broker node BR4 can also be selected in the composite event detection/distribution system and set as a route node for a composite event

Event routing table 309 is set on broker nodes BR23, BR24, BR19, BR14, BR9 and BR4 by performing the above described processing and a distribution path for a composite event C1 is set. The distribution path shown in FIG. 13 is an example and a distribution path for a composite event C1 may also be set through a different route according to the set content in event routing table 309 of each broker node BR1 to BR25.

To be exact, the above described processing may be divided into two kinds of processing. That is, the processing may be divided into two kinds of processing; a phase for confirming a route node of composite event C1 and a phase for registering a distribution path for composite event C1. In this case, subscriber node S3 confirms route node R3 in the first phase and each broker node BR23, BR24, BR19, BR14, BR9 or BR4 sets event routing table 309 in the second phase.

FIG. 14 is a diagram illustrating composite event registration information registered with route node R3 set on broker node BR4 in response to the request from subscriber node S3. The example shown in FIG. 14 shows a case where composite event registration information for detection of composite event C1 generated by combining two events A1 and B1 is registered. The composite event registration information shown in FIG. 14 is stored in a storage apparatus such as a memory or magnetic disk apparatus provided for route node R3 (to be more specific, broker node BR4).

The composite event registration information registered with route node R3 as shown in FIG. 14 includes composite event ID 401, event ID 402 for identifying associated event A1, event ID 403 for identifying associated event B1 and association conditional expression 404.

Association conditional expression 404 is a conditional expression to judge whether or not route node R3 has detected composite event C1. Route node R3 judges whether or not composite event C1 has been detected according to, for example, association conditional expression 404 shown below.

(1) Association conditional expression of simultaneous occurrence “A1 AND B1”: In this case, upon detecting both the occurrence of associated event A1 and the occurrence of associated event B1, route node R3 judges that composite event C1 has occurred.

(2) Association conditional expression of selective occurrence “A1 OR B1”: In this case, upon detecting the occurrence of associated event A1 or the occurrence of associated event B1, route node R3 judges that composite event C1 has occurred.

(3) Association conditional expression of sequential occurrence “A1 THEN B1”: In this case, upon detecting the occurrence of associated event B1 after detecting the occurrence of associated event A1, route node R3 judges that composite event C1 has occurred.

(4) Association conditional expression of sequence, time specification “A1 THEN B1” (associated event B1 occurs within five seconds after the occurrence of associated event A1 or associated event B1 occurs five seconds after the occurrence of associated event A1 or the like): In this case, upon detecting the occurrence of associated event B1 within five seconds (or after five seconds) after detecting the occurrence of associated event A1, route node R3 judges that composite event C has occurred.

Association conditional expression 404 is not limited to those shown in (1) to (4) above. For example, route node R3 may also judge that composite event C1 has occurred on the basis of the fact that the same event has consecutively occurred (e.g., how many times composite event C1 has occurred within a certain period of time) using association conditional expression 404.

Furthermore, composite event ID 401 shown in FIG. 14 is used to confirm a route node for composite event distribution. As described above, broker node BR4 with a node ID numerically close to composite event ID 401 is selected as route node R3 in the present embodiment.

Furthermore, basic type ID and event ID 402 corresponding to associated event A1 and basic type ID and event ID 403 corresponding to associated event B1 shown in FIG. 14 are used when route node R3 for a composite event identifies a route node for detection of associated events A1 and B1.

Processing for detecting a composite event is performed by route node R3 on broker node BR4 after route node R3 is set through processing in steps S201 to S203. First, route node R3 performs registration to detect associated event A1. Thus, route node R3 transmits registration information to route node R1 which is a route node for event A1 (step S204).

In the example shown in FIG. 13, registration information transmitted from route node R3 is routed in order of broker node BR3, broker node BR2 and broker node BR7 through transfer processing according to event routing table 309 of each broker node. Each broker node BR3, BR2, BR7 sets event routing table 309 on the basis of the transferred registration information. In the example shown in FIG. 13, broker node BR7 can find a route through which event A1 is distributed from publisher node P1 to subscriber node S5 via route node R1, and registration processing is completed when broker node BR7 sets event routing table 309.

FIG. 15 is a diagram illustrating an example of a message used for registration processing to detect associated event A1. Each broker node BR3, BR2, BR7 performs routing processing using basic type ID 402 of associated event A1 included in the message of registration information shown in FIG. 15 as a key in the transfer route of registration information from route node R3 to route node R1.

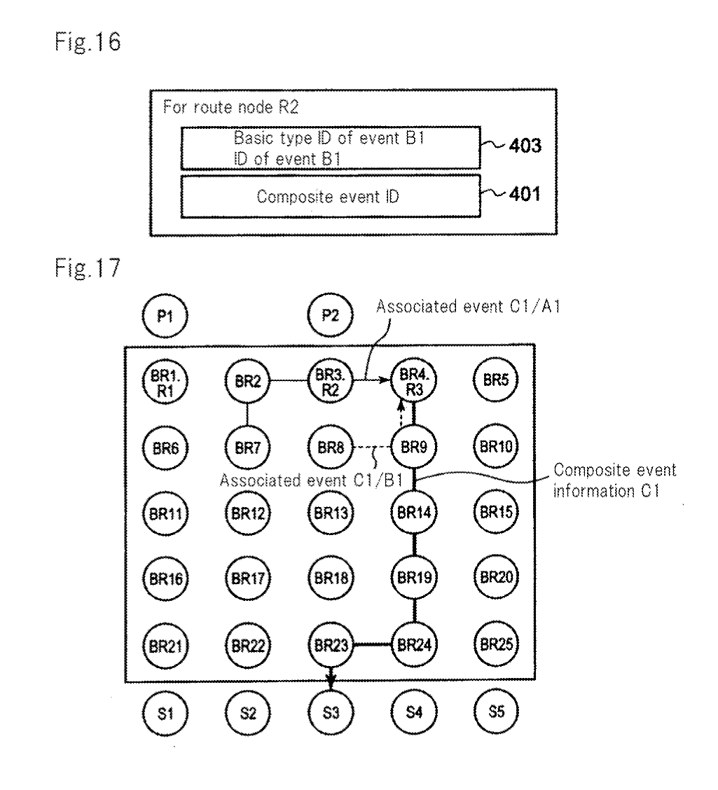

As in the case of the registration processing of associated event A1, route node R3 transmits registration information to route node R2 which is a route node for event B1, also for associated event B1 (step S205). In this case, each broker node BR9, BR8 sets event routing table 309 according to processing similar to the registration processing of associated event A1. Since broker node BR8 can find out the distribution route of associated event B1, registration processing is completed when broker node BR8 sets event routing table 309. FIG. 16 shows registration information (message) used in the registration processing to detect associated event B1.

By performing the above described processing, route node R3 can receive two events; associated event A1 (distributed from publisher node P1 to subscriber node S5) and associated event B1 (distributed from publisher node P2 to subscriber node S1).

After the above described setting, when event A1 is distributed from publisher node P1 to subscriber node S5, broker node BR7 that relays the event detects that the event is registered associated event A1. Broker node BR7 then creates a copy of event A1, transfers one to broker node BR13 so as to be distributed to subscriber node S5 and transfers the other to broker node BR2 so as to be distributed to route node R3 as associated event A1 as shown in FIG. 17 (step S206).

Furthermore, when event B1 is distributed from publisher node P2 to subscriber node S1, broker node BR8 that relays the event detects that the event is registered associated event B1. Broker node BR8 then creates a copy of event B1, transfers one to broker node BR12 so as to be distributed to subscriber node S1 and transfers the other to broker node BR9 so as to be distributed to route node R3 as associated event B1 as shown in FIG. 17 (step S207).

Next, upon receiving associated events A1 and B1, route node R3 generates composite event C1 on the basis of received associated events A1 and B1 (step S208). Route node R3 then distributes composite event C1 generated to subscriber node S3 (step S209).

In the example shown in the present embodiment, new composite event C1 generated by combining two associated events A1 and B1 is distributed to subscriber node S3 via the route from route node R3 (broker node BR4) to broker nodes BR9, BR14, BR19, BR24 and BR23 as shown in FIG. 17. in the example shown in FIG. 17, event A1 that is detected by broker node BR7 is expressed as associated event A1 of composite event C1. Likewise, event B1 that is detected by broker node BR8 is expressed as associated event B1 of composite event C1.

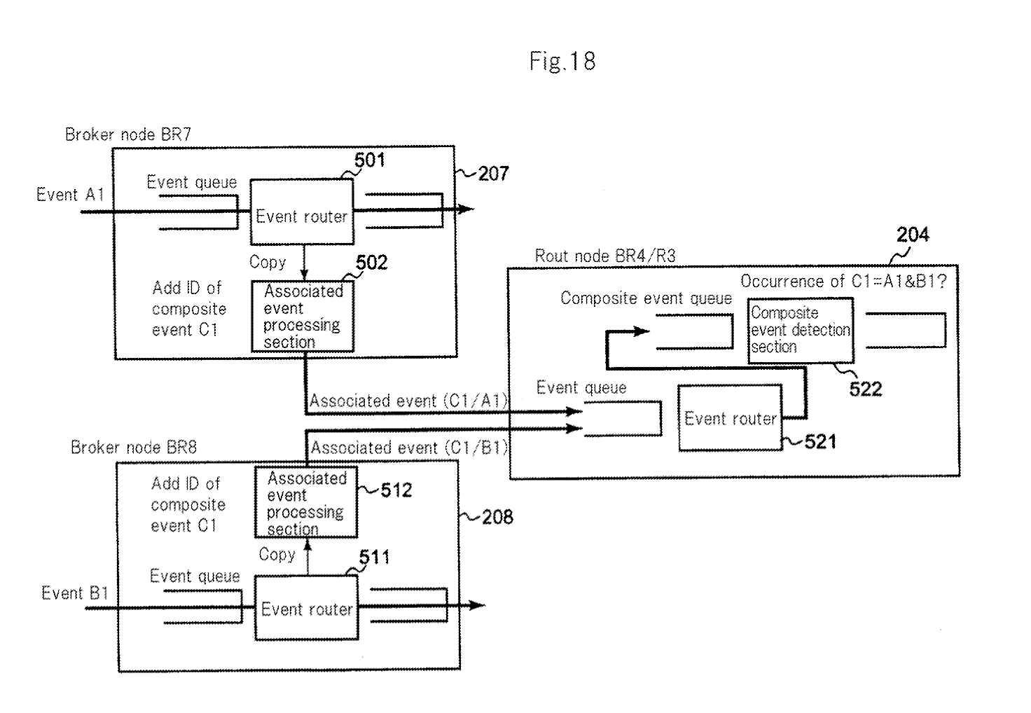

Next, the operations of collecting associated events A1 and B1 and detecting composite event C1 at broker nodes BR7, BR8 and BR4 will be described. FIG. 18 is a diagram illustrating the operation of collecting associated events A1 and B1 and detecting composite event C1. The example shown in FIG. 18 shows a model in which composite event C1 is generated using two associated events; associated event A1 and associated event B1. The composite event detection/distribution system may also be configured so as to detect and distribute a composite event using three or more associated events.

As shown in FIG. 10, associated event A1 is an event directed from publisher node P1 to subscriber node S5. Furthermore, as shown in FIG. 11, associated event B1 is an event directed from publisher node P2 to subscriber node S1. In the example shown in FIG. 18, suppose that registration processing for collection of associated events A1 and B1 for broker nodes BR7 and BR8 by route node R3 has already been completed.

Upon receiving event A1, broker node BR7 temporarily stores received event A1 in an event queue. Event router 501 in broker node BR7 performs routing processing on events stored in the event queue one by one. Upon detecting event A1 in this routing processing, the event router creates a copy of event A1. In this case, the event router outputs original event A1 to an event queue for transmission. Broker node BR7 then distributes original event A1 to subscriber node S5 via other broker nodes BR3, BR14, BR5, BR20 and BR25 as shown in FIG. 10.

Furthermore, the event router outputs copied event A1 to associated event processing section 502. Associated event processing section 502 then adds an ID of composite event C1 to copied event A1 to indicate that it is an event associated with the composite event. In FIG. 18, the event to which the ID of composite event C1 is added is denoted as associated event C1/A1 to make a distinction from original event A1.

Associated event C1/A1 shown in FIG. 18 is finally transferred to broker node BR4 as shown in FIG. 17. Event router 521 in broker node BR4 then performs routing processing, thereby detects associated event C1/A1 and adds detected associated event C1/A1 to a composite event queue.

Furthermore, broker node BR8 also performs processing similar to that of broker node BR7, creates associated event C1/B1 as shown in FIG. 18 and finally transfers associated event C1/B1 to broker node BR4. As a result, broker node BR4 (route node R3) integrates associated event C1/A1 and associated event C1/B1.

Composite event detection section 522 of broker node BR4 executes composite event detection processing and detects the occurrences of associated event C1/A1 and associated event C1/B1. Next, composite event detection section 522 detects (generates) composite event C1 on the basis of associated event C1/A1 and associated event C1/B1 if the associated events meet the set association conditional expression. Composite event detection section 522 then distributes detected composite event C1 to subscriber node S3 via the route described in FIG. 17 (route that passes through broker nodes BR9, BR14, BR19, BR24 and BR25).

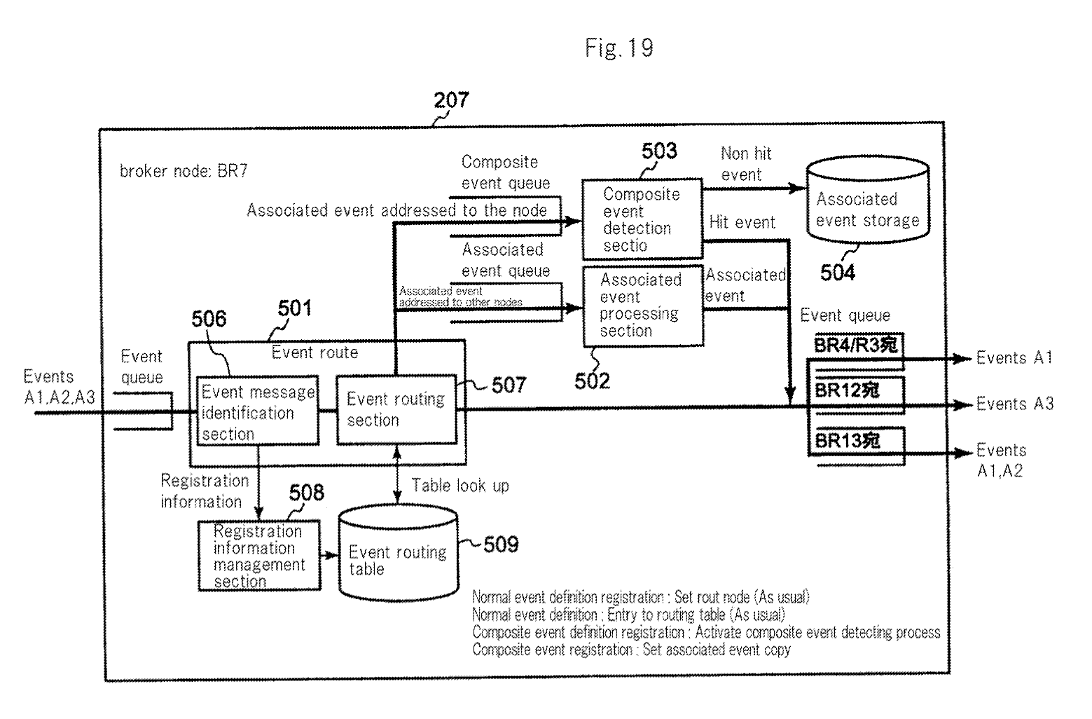

Next, the operation of each broker node included in the composite event detection/distribution system will be described. FIG. 19 is a diagram illustrating the operation of each broker node. The example shown in FIG. 19 shows a case with broker node BR7 as an example, but other broker nodes included in the composite event detection/distribution system can also perform similar operations.

There can be various definitions regarding a relationship between a plurality of events that can be a condition of composite event detection. For example, there can be definitions of various composite events such as “associated event A1 and associated event B1 that have occurred simultaneously,” “associated event B1 that has occurred after associated event A1,” “associated event B1 that has occurred within five seconds after associated event A1” and “associated event B1 that has occurred five seconds or more after associated event A1.”

Here, it is difficult for associated event A1 and associated event B1 to arrive at broker node BR4 (route node R3) simultaneously. Therefore, as shown in FIG. 19, broker node BR7 applies measures capable of detecting a composite event even if there is a time difference in arrival time between associated events.

As shown in FIG. 19, broker node BR7 is provided with both the function of performing an operation of detecting an associated event and transferring the event to a route node and the function of operating as a route node for composite event detection as shown in FIG. 18.

That is, when set as a node for associated event detection, broker node BR7 executes associated event processing upon detecting associated event A1 or B1. On the other hand, when set as a route node for composite event detection, broker node BR7 executes composite event processing upon receiving an associated event. This broker node BR7 stores received associated events in associated event storage 504. As for this associated event storage 504, there can be various implementation modes using various storage media such as a memory, magnetic disk apparatus or distributed storage.

When detecting a composite event, bmker node BR7 searches associated events stored in associated event storage 504 first. Here, if an associated event is detected which matches the composite event detection condition, broker node BR7 generates a composite event using the received associated event and the stored associated events. Broker node BR7 then distributes the composite event generated as a hit event. For example, as shown in FIG. 17, broker node BR7 distributes this hit event to subscriber node S3 as composite event C1.

On the other hand, if no matching associated event is found in the search processing, broker node BR7 stores the received associated event in associated event storage 504 as a non-hit event. Broker node BR7 (to be more specific, composite event detection section 503) performs processing of deleting old associated events such as those continuously stored for a predetermined period or more so as to prevent any overflow of associated event storage 504. For example, composite event detection section 503 judges the storage start date and time of each associated event stored in associated event storage 504 for every predetermined period and deletes all associated events judged as having passed for the predetermined period or more after the start of storage.

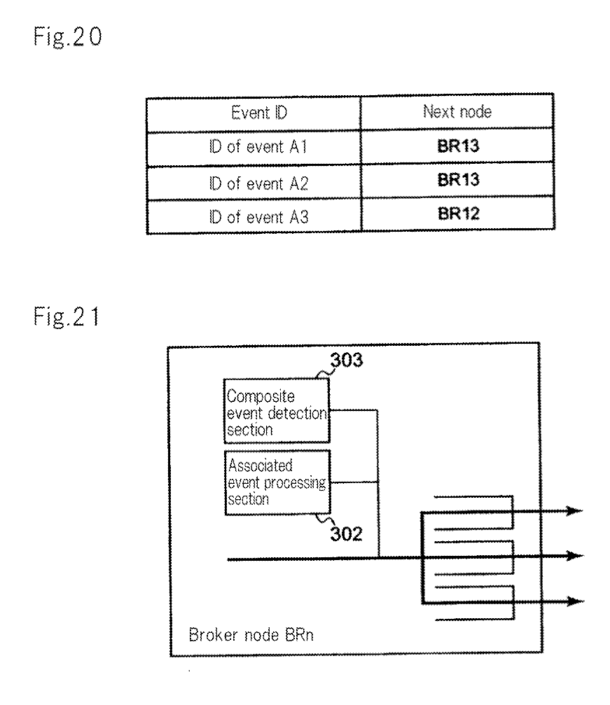

FIG. 20 is a diagram illustrating an example of event routing table 509 used by event routing section 507 of event router 501. Event registration information of event routing table 509 shown in FIG. 20 is detected by event message identification section 506 and the table is constructed by registration information management section 508 on the basis of the detected event registration information.

With the above described configuration, individual events are concentrated on a broker node having the function of detecting and distributing a composite event, a composite event is then generated and the composite event generated is distributed to a subscriber node.

As described above, according to the present embodiment, the route node function for distributing a composite event can be distributed for each type of composite event. Furthermore, it is possible to distribute the function as a route node that detects/distributes a composite event and the function of detecting an associated node associated with the detection of the composite event. Therefore, it is possible to reduce concentration of a load on a node that detects and distributes a composite event as the number of types of composite events increases.

Furthermore, according to the present embodiment, the amount of data transferred other than events can be reduced by combining a plurality of existing event distribution trees and a newly constructed composite event distribution tree. Therefore, an increased load on the network can be reduced as the number of types of composite events increases.

The present embodiment has described the case where all broker nodes BR1 to BR25 included in the composite event detection/distribution system are configured to be settable as route nodes, but only some of the plurality of broker nodes may be configured to be settable as route nodes. In this case, although the system requires a node (e.g., management server) that manages broker nodes in the composite event detection/distribution system which can be set as route nodes, it is possible to eliminate the need to mount the setting function as route nodes on all broker nodes, and thereby achieve a cost reduction.

Next, a minimum configuration of the composite event detection/distribution system of the present invention will be described. FIG. 21 is a block diagram illustrating a minimum configuration example of the composite event detection/distribution system. As shown in FIG. 21, the composite event detection/distribution system is provided with a broker node as a minimum component. Furthermore, the broker node includes associated event processing section 302 and composite event detection section 303. Furthermore, the broker node has a function of operating as a route node that performs distribution processing on a composite event generated by combining a plurality of events and a function of operating as an associated event detection node that detects associated events associated with the detection of the composite event.

In the composite event detection/distribution system in the minimum configuration shown in FIG. 21, associated event processing section 302 is provided with a function of transferring, upon detecting an associated event, when the system is set as an associated event detection node, the detected associated event to a broker node set as a route node. Furthermore, composite event detection section 303 is provided with a function of generating, upon receiving an associated event from a broker node set as an associated event detection node, when the system is set as a route node, a composite event on the basis of the received associated event. Composite event detection section 303 is provided with a function of transferring the generated composite event to another node according to the set content

According to the composite event detection/distribution system in the minimum configuration shown in FIG. 21, the system can reduce concentration of a load on a node that detects and distributes a composite event as the number of types of composite event increases.

The present embodiment shows characteristic configurations of the composite event detection/distribution system as shown in (1) to (8) below.

(1) The composite event detection/distribution system is provided with a plurality of broker nodes (e.g., broker nodes BR1 to BR25) that relay event distribution, each broker node having a function of operating as a route node (e.g., route node R3 shown in FIG. 17) that performs distribution processing on a composite event generated by combining a plurality of events and a function of operating as an associated event detection node (e.g. broker nodes BR7 and BR8 shown in FIG. 17), that detects an associated event associated with the detection of the composite event, the system including an associated event transfer section (e.g., realized by associated event processing section 302) that transfers, upon detecting an associated event, when the system is set as an associated event detection node, the detected associated event to a broker node set as a route node, a composite event generation section (e.g., realized by composite event detection section 303) that generates, upon receiving an associated event from a broker node set as an associated event detection node, when the system is set as a route node, a composite event on the basis of the received associated event, and a composite event distribution section (e.g., realized by composite event detection section 303) that transfers the composite event generated by the composite event generation section to another node according to the set content.

(2) The composite event detection/distribution system may also be configured such that the composite event distribution section distributes a composite event to a subscriber node as a result of the transfer.

(3) The composite event detection/distribution system may also be configured such that the composite event generation section judges whether or not a predetermined composite event detection condition has been met on the basis of an associated event received from a broker node set as an associated event detection node and generates a composite event upon judging that the predetermined composite event detection condition is met.

(4) The composite event detection/distribution system may also be configured so as to include a publisher node (e.g., publisher nodes P1 and P2) that generates an event and transmits the generated event and a subscriber node (e.g., subscriber nodes S1 to S5) that receives the event transmitted by the publisher node, wherein the subscriber node includes a reception registration section (e.g., realized by route node setting requesting section 204) that transmits registration information for receiving a composite event to a broker node selected as a route node and thereby performs reception registration beforehand and the composite event distribution section distributes the composite event generated by the composite event generation section to the subscriber node subjected to reception registration beforehand.

(5) The composite event detection/distribution system may also be configured such that the subscriber node includes a registration information generation section (e.g., realized by composite event registration information generation section 203) that generates registration information including information indicating types of a plurality of associated events associated with the detection of a composite event (e.g., basic type ID of event A1 and ID 402 of event A1, basic type ID of event B1and ID 403 of event B1) and a relational expression (e.g., realized by association conditional expression 404) indicating a relationship between a plurality of associated events, wherein the reception registration section transmits the registration information generated by the registration information generation section to the broker node selected as a route node.

(6) The composite event detection/distribution system may also be configured such that the broker node selected as the route node includes an associated event detection node setting requesting section (e.g., realized by associated event processing requesting section 310) that causes a broker node that relays each associated event to be set as an associated event detection node using information indicating the types of a plurality of associated events included in the registration information of the composite event received from the subscriber node.

(7) The composite event detection/distribution system may also be configured such that the broker node set as a route node includes an associated event storage section (e.g., realized by associated event storage 304) that stores the associated events received from the broker node set as an associated event detection node and the composite event generation section searches an associated event stored in the associated event storage section and generates a composite event on the basis of the searched associated event.

(8) The composite event detection/distribution system may also be configured such that the broker node set as a route node includes an associated event deletion section (e.g., realized by composite event detection section 303) that scans associated events stored in the associated event storage section for every predetermined period irrespective of the presence/absence of a received associated event and deletes, when an associated event stored for a predetermined period or more exists, the associated event stored for the predetermined period or more.

The present invention is applicable, for example, to monitoring of an operating situation of a large-scale network system. That is, by combining various events that occur in the network system, it is possible to realize high-level visualization of the network. Furthermore, when the present invention is applied to congestion information in an Intelligent Traffic System (ITS), it is possible to construct a high-level information distribution environment by combining and distributing events obtained from various kinds of sensing data. Moreover, the present invention can also provide various sensing systems already realized in recent ubiquitous service regions with a space for exchanging events between systems.

The present invention has been described with reference to the embodiment, but the present invention is not limited to the embodiment. Configurations and details defined in the claims can be modified in various ways understandable to those skilled in the art within the scope of the invention.

The present application claims a priority on the basis of Japanese Patent Application No. 2008-050220, filed on Feb. 29, 2008, the disclosure of which is incorporated herein by reference in its entirety.

1-21. (canceled)

22. A composite event detection/distribution system comprising:
an associated event detection node that transfers, when detecting an associated event associated with the detection of a composite event generated by combining a plurality of events, the associated event that is detected to a route node;
and the route node that generates, when receiving the associated event from the associated event detection node, a composite event on the basis of the associated event that is received and that transfers the generated composite event to another node according to aset content.

23. The composite event detection/distribution system according to claim 22, wherein the route node distributes the generated composite event to a subscriber node.

24. The composite event detection/distribution system according to claim 22, wherein the route node judges whether or not a predetermined composite event detection condition is met on the basis of the received associated event and generates a composite event when the predetermined composite event detection condition is met.

25. The composite event detection/distribution system according to claim 22, further comprising:
a publisher node that generates an event and transmits the event that is generated; and
a subscriber node that receives the event from the publisher node and transmits a reception registration request for requesting that the subscriber node itself receive the composite event from the route node to the route node,
wherein the route node receives the reception registration request from the subscriber node and transmits the composite event that is generated to the subscriber node on the basis of the reception registration request.

26. The composite event detection/distribution system according to claim 25, wherein the reception registration request comprises a relational expression indicating types of a plurality of associated events associated with the detection of the composite event and a relationship between a plurality of associated events.

27. The composite event detection/distribution system according to claim 26, wherein the route node transmits a setting request that requests a broker node that relays each associated event to set the broker node as the associated event detection node on the basis of the types of the plurality of associated events included in the received reception registration request.

28. The composite event detection/distribution system according to claim 22, wherein the route node stores the associated events that are received from the associated event detection node, searches an associated event that meets a predetermined condition from among the stored associated events and generates the composite event on the basis of the searched associated events.

29. The composite event detection/distribution system according to claim 28, wherein the route node scans the associated events stored for every predetermined period and deletes the associated event stored for a predetermined period or more.

30. A broker node comprising:
receiving means for receiving an associated event generated by combining a plurality of events;
composite event generating means for generating a composite event on the basis of the associated event that is received by the receiving means; and
composite event distributing means for transferring the composite event generated by the composite event generating means to another node according to a set content.

31. The broker node according to claim 30, wherein the composite event distributing means distributes the composite event to a subscriber node.

32. The broker node according to claim 30, wherein the composite event generating means judges whether or not a predetermined composite event detection condition is met on the basis of the associated event and generates a composite event when the predetermined composite event detection condition is met.

33. A composite event detection/distribution method comprising:
transferring, when detecting an associated event associated with the detection of a composite event generated by combining a plurality of events, the associated event detected to a route node;
generating, when receiving the associated event, a composite event on the basis of the associated event received; and
transferring the generated composite event to another node according to a set content.

34. The composite event detection/distribution method according to claim 33, wherein the composite event is distributed to a subscriber node.

35. The composite event detection/distribution method according to claim 33, judging whether or not a predetermined composite event detection condition is met on the basis of the received associated event and generating a composite event when the predetermined composite event detection condition is met.
